(19) United States
(12) Patent Application Publication
(10) Pub. No.: US 2009/0106315 A1
(43) Pub. Date: Apr. 23, 2009

(54) EXTENSIONS FOR SYSTEM AND METHOD FOR AN EXTENSIBLE MEDIA PLAYER

(75) Inventors: Manish UPENDRAN, San Jose, CA (US); Tomi BLINNIKKA, San Pablo, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/165,290

(22) Filed: Jun. 30, 2008

Related U.S. Application Data
(63) Continuation-in-part of application No. 11/874,171, filed on Oct. 17, 2007.

(51) Int. Cl. G06F 17/30; G06F 15/16

(52) U.S. Cl. 707/104.1; 709/203; 707/E17.009

(57) ABSTRACT

In a method and system for creating an extensible media player, a multimedia player application is instantiated on a client system. A presentation data file is transmitted to the client system from a server. The presentation data file includes a playlist of timelines, modules associated with each of the timelines of the playlist, and a presentation theme for each of the modules. Each module extends the functionality of the instantiated multimedia player and includes a user interface element having a reconfigurable presentation. Each presentation theme defines presentation attributes for a user interface element. A module identifies one or more multimedia files to be played or one or more applications to be executed by the multimedia player application. The presentation data file is parsed to identify the modules associated with each of the timelines of the playlist as well as a presentation theme associated with each of the modules. For a selected timeline, the modules associated with the selected timeline are loaded. Each module associated with the selected timeline is notified of the presentation theme to be applied to the module. In response to the notification, each module retrieves presentation attributes corresponding to the presentation theme and applies the presentation attributes to its user interface element.

### CROSS-REFERENCE TO RELATED APPLICATIONS

The present application is a continuation-in-part of application Ser. No. 11/874,171, filed Oct. 17, 2007, entitled, “System and Method for an Extensible Media Player”. The present application incorporates this earlier-filed application by reference.

### BACKGROUND

1. Field of the Invention

Aspects of the present invention relate generally to a media player, and more particularly, to an extensible media player.

2. Description of Related Art

Current media player solutions found on Internet web pages are designed and written like most computer applications. When a new feature is to be added to the media player, the feature must be written into the main media player application, essentially requiring a full product cycle. This increases the deployment time of the media player.

Current media player solutions also fail to provide a fully dynamic system to program the user experience on-the-fly. While solutions exist to render different visual items based on cue points within the media being played or based on pre-defined criteria, these items are fixed and must be pre-programmed with the media being played.

Thus, it would be desirable to provide a method and system for creating an extensible media player capable of being modified dynamically to provide a highly interactive experience for a user.

### SUMMARY

Embodiments of the present invention overcome the above-mentioned and various other shortcomings of conventional technology, providing a method and system for creating an extensible media player.

In accordance with one aspect, a media player application may be instantiated on a client system. A presentation data file may be transmitted to the client system. The presentation data file may identify a playlist of timelines, modules associated with each of the timelines of the playlist, and a presentation theme for each of the modules. Each module may extend the functionality of the instantiated multimedia player and may include a user interface element having a reconfigurable presentation. Each presentation theme may define presentation attributes for the user interface element. A module associated with a timeline may identify one or more multimedia files to be played or one or more applications to be executed by the multimedia player application. The presentation data file may be parsed to identify the modules associated with each of the timelines of the playlist as well as a presentation theme associated with each of the modules. For a selected timeline, the modules associated with the selected timeline may be loaded. Each module associated with the selected timeline may be notified of the presentation theme to be applied to the module. In response to the notification, each module may retrieve presentation attributes corresponding to the presentation theme and apply the presentation attributes to its user interface element.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a simplified diagram illustrating an embodiment of a system for providing an extensible media player.

FIG. 2 illustrates an embodiment of an extensible media player system.

FIG. 3 illustrates an embodiment of an extensible media player application.

FIG. 4 illustrates an embodiment of an extensible media player application.

FIG. 5 illustrates an embodiment of an extensible media player application.

FIG. 6 illustrates an embodiment of an extensible media player application.

FIG. 7 is a flowchart illustrating one embodiment of a method for providing an extensible media player.

FIG. 8 illustrates an embodiment of a software platform supporting an extensible media player.

FIG. 9 illustrates an embodiment of an extensible media player.

FIG. 10 illustrates an embodiment of an extensible media player platform.

FIG. 11A illustrates an embodiment for module communication.

FIG. 11B illustrates an embodiment for module communication.

FIG. 12 illustrates a sample optimized data file for describing and configuring a media player application.

FIG. 13 is a flowchart illustrating one embodiment of a method for providing an extensible media player.

### DETAILED DESCRIPTION

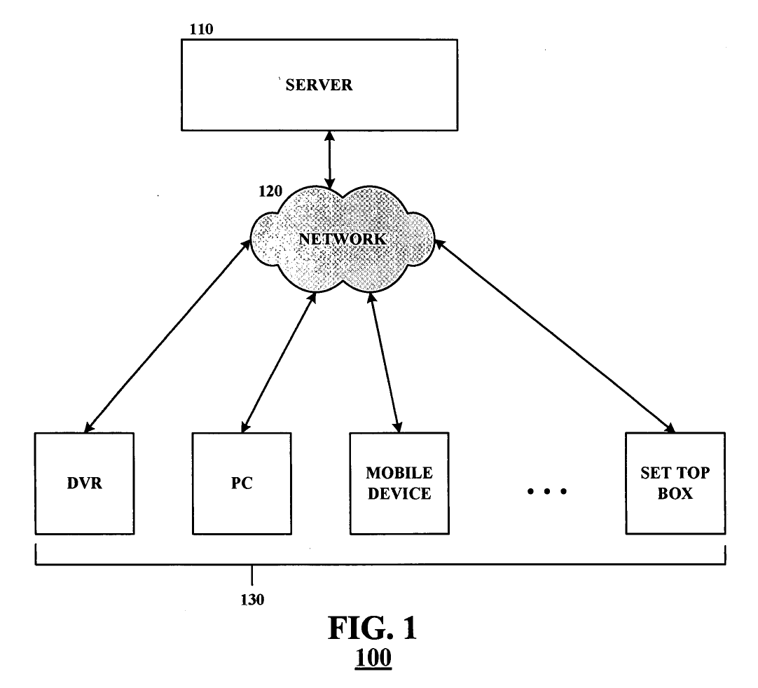

FIG. 1 is a simplified diagram illustrating one embodiment of a system for providing an extensible media player. The system 100 includes one or more servers storing a plurality of media files. The media files may be encoded in any format, including but not limited to the mpeg, avi, wmv, wma, mov, wav, mp3, aau, m4a, m4p, MIDI, and DivX formats. Various other encoding formats may be used advantageously with the embodiments described herein below; differences between these formats are immaterial to the present discussion unless otherwise noted. The servers also may store a player application, which may be passed to a plurality of client devices, and a plurality of modules, each of which may extend a functionality aspect or presentation aspect of the player application. Each module may include visual items, application logic, or a combination of the two. The servers may create and store a presentation data file based on user requests and third party requests, such as requests from content providers and advertisers. The presentation data file also may be created editorially. The presentation data file may be a XML-based file, such as, for example, a Media RSS (MRSS) file with extensions for the player application. The presentation data file may define the media items available to be played by the player application, as well as the player application components (i.e., modules) to be displayed for each media item. The presentation data file also may specify when each module associated with each media item becomes active and inactive, as well as the location of each module in the media player application. The presentation data file may be transmitted to any of the plurality of client devices.

The system also may include a plurality of client devices capable of instantiating or executing a media player application to play a media file, such as a video file or an audio file. The devices may include but are not limited to personal computers, digital video recorders (DVRs) or personal video recorders (PVRs), set top boxes which may receive content through cable, satellite, or Internet Protocol via network infrastructure including but not limited to wireless media and fiber optic cable (e.g., IPTV or Internet television), and mobile devices, such as cell phones, personal digital assistants (PDAs), or other wireless devices capable of playing video files. Each device may include software to process and play media files. The software may comprise a standalone media player capable of playing media files and parsing the presentation data file to execute modules. Alternatively, the software may include an Internet browser or other software in which the media player application, in the form of, for example, a Java applet or Flash-based player, may be instantiated or embedded. A client device may be configured to send a request through a network to the server to access one of the media files presented in the presentation data file. In response to a request from a connected device, a server may stream or transfer the selected media file(s) and accompanying modules associated with the selected media file over a network to the requesting device.

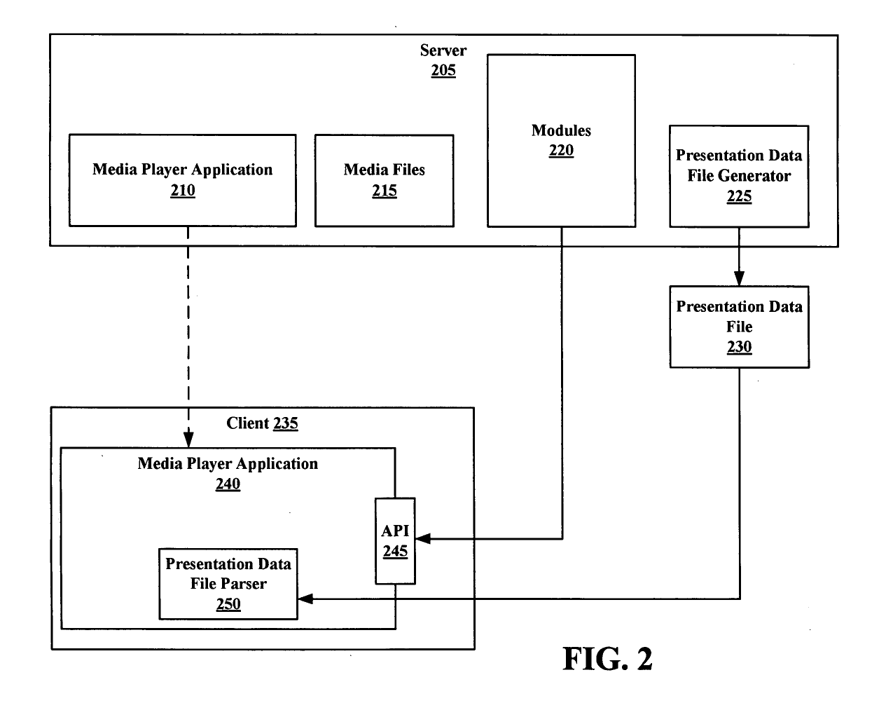

FIG. 2 illustrates an embodiment of a system for providing an extensible media player. The system may include a server 205 connected, in one embodiment, through a wired or wireless network, to a client device 235, such as a personal computer or portable communications device (e.g., a wireless telephone or Personal Digital Assistant (PDA)). The server 205 may store a media player application 210 or software code for implementing or instantiating a media player application on the client device 235, one or more media files 215, and one or more modules 220. The server 205 also may store presentation data files or include a presentation data file generator 225 which generates presentation data files.

The media files 215 may have any video or audio or mixed video/audio format, including but not limited to the types mentioned earlier. The particular format of the media files 215 stored in the server 205 is immaterial for the purposes of the present discussion, unless otherwise noted. The media files need not be stored in only one server, and may be stored in multiple servers. The one or more modules may provide additional player functionality or presentation features for the media player application. Examples of modules may include but are not limited to a player controls module, a playlist module to display available media files, a pre-timeline curtain module to display an advertisement prior to a media file, a banner to display a presentation aspect during playing of a media file, a post-roll curtain to display a presentation aspect subsequent to the playing of a media file, and a container to display third party content. Generally, modules may be designed and stored to interface with the media player application prior to, during, or subsequent to the playback of a media file. The modules may control an aspect of the playback of media files or may affect an aspect of the presentation of the media player application to a user.

The modules related to presentation aspects of the media player application may either transparently overlay or fully obscure part or all of the media file being played. Each module may have a default aspect ratio of 4:3, but may have logic necessary to conform to other aspect ratios, such as 16:9. Each module also may be resizable to any size. The modules may be configured to retrieve additional data from remote sources, such as the server, if needed, or to record and transmit usage information to the remote source. For example, if a closed captioning module is associated with a media file, the closed captioning module may retrieve the closed captioning data from a remote source to present to a user. The modules 220 also may be interactive, thereby enabling the user to control presentation of the media file or to access additional related content presented to the user before, during, or after presentation of the media file. In one embodiment, the media player application 240 and the modules 220 may be Flash-based components conforming to a specific version of Flash, including but not limited to, Flash 9. The container module may enable non-Flash third party content or third party content not conforming to a specific version of Flash to be displayed in conjunction with the media file being played in the media player application.

The presentation data files, either stored in the server 205 or generated by the presentation data file generator 225, may define a set of available media files to be played (i.e., a playlist) as well as media player application components 220 (i.e., modules) to be executed or displayed for each media item of the playlist. The presentation data file may further define the modules 220 by defining the ordering and timing of the modules 220 for a given media file (i.e., when a module is active and inactive). The timing of the modules 220 may be expressed as a function of time, events, or elapsed frames of the media file with which the module is associated. For modules 220 relating to the presentation of the media file to a user, the presentation data file also may specify the location and placement of the module within the media player application. The presentation data file may be a XML-based file such as a Media RSS (MRSS) file. Alternatively, the presentation data file may be a binary file. As a binary file may have a smaller file size than other file formats, the length of time to download a binary presentation data file may decrease, thereby improving performance of the system. A sample presentation data file is shown below:

```
<rss version=“2.0” xmlns:media=http://search.yahoo.com/mrss
      xmlns:yemp=“http://schemas.yahoo.com/yemp/”>
  <channel>
      <!-- Modules that are used for all items -->
      <yemp:module start=“0”
source=“http://server.yahoo.com/yemp/modules/PlayerControls.swf”
    zIndex=“9000” />
      <item>
        <yemp:module start=“before”
    source=“http://server.yahoo.com/yemp/modules/StartFrame.swf”
parameters=
“src=http://server.yahoo.com/yemp/temp/SampleThumbnail.jpg”
    zIndex=“9000” />
        <media:content
            url=“http://server.corp.yahoo.com/yemp/temp/test.flv”
            type=“video/x-flv”>
            <media:title>A ye olde TV Tuning</media:title>
            <media:description>TV tuning video
clip</media:description>
            <media:thumbnail
              url=“http://i.imdb.com/Photos/Mptv/1388/th-
5746_0077.jpg”
              height=“50” width=“75” />
        </media:content>
      <yemp:module start=“after”
    source=“http://server.yahoo.com/yemp/modules/PostRoll.swf”
      </item>
  </channel>
</rss>
```

The presentation data file may enable presentation aspects and application logic to be dynamically changed for a media file. For instance, the above sample presentation data file includes a player controls module, a start frame module, and a post-roll module. However, different modules may be substituted on-the-fly by modifying the presentation data file to call other modules. The placement or timing of the modules may be dynamically modified by changing the specifications for the various modules listed in the presentation data file, such as the “height,” “width,” and “module start” parameters.

The client device may execute a standalone media player application 240 or instantiate a media player application 240, within, for instance, an Internet browser. In one embodiment, the media player application 240 may be a Flash-based application. In one embodiment, the media player application 240 may be created as a Microsoft Silverlight™ application capable of playing WMV and WMA media files. The media player application 240 may serve as a platform for the extensible media player, and may include an Application Programming Interface (API) 245 which communicates with the various modules. In this respect, the API 245 may enable the modules 220 to interface with the player application 240 and control the presentation and playback aspects of the player application 240. In one embodiment, the player application API 245 may be public, thereby enabling distributed development of modules.

The presentation data file may be passed to the media player application from within a web page as a parameter or programmatically via JavaScript if the media player application is embedded on a web page. Alternatively, the presentation data file may be retrieved from the network by the media player application if the media player application is given or has knowledge of the source address of the presentation data file. A presentation data file parser 250 may parse the presentation data file 230 to reveal a playlist of media files available for playback. In one embodiment, the presentation data file parser 250 may be integrated into the media player application 240. In one embodiment, the playlist may list a set of FLV videos. An instance of the playlist may be passed to the instantiated or executed media player application, which may further parse the playlist to identify playlist items corresponding to available media files. Each playlist item may have a presentation instance that identifies the modules associated with the playlist item. The playlist items on the playlist may each include an address or link to the location where a corresponding media file 215 is stored. In response to the selection of a playlist item from the playlist, the player application 240 may transmit a request to the server 205 to download or stream the selected media file 215. While the embodiment discussed herein may identify a single server storing media files and modules, it is contemplated that multiple servers may be employed to store modules, media files, and, if the application is instantiated on a client device, an application SWF file. The present invention is not intended to be limited with respect to the number of servers employed, and it is conceivable that each component or aspect of the extensible media player may originate from or be located in a different location. Modules 220 associated with the selected media file also may be downloaded. In one embodiment, the modules 220 may be downloaded separately. Alternatively, the modules 220 may be packaged as one file at the server and downloaded to the client, thereby minimizing network traffic. Packaging the modules as one file may also reduce the load time of the modules, thereby improving the user viewing experience. The media player application 240 may load the selected media file 215 and the downloaded modules 245 for playback and presentation to the user.

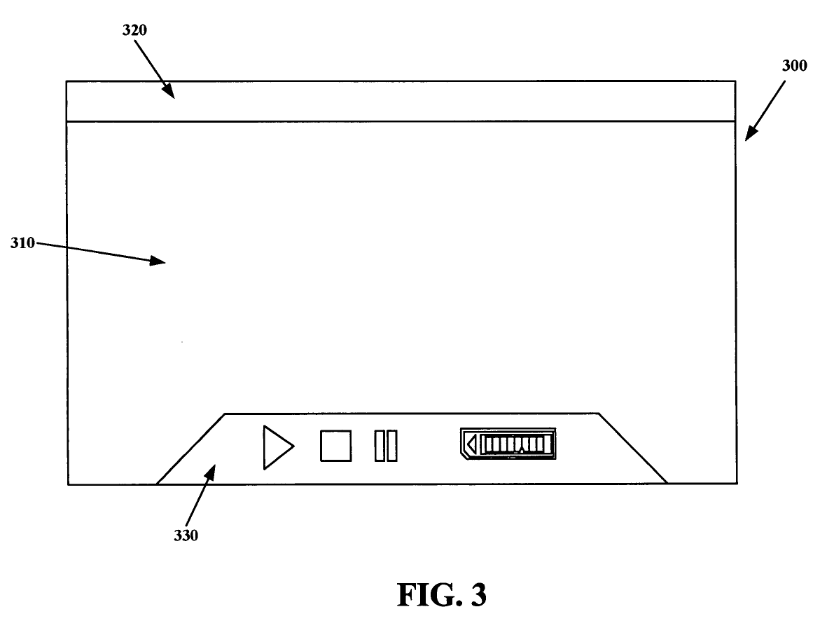

FIG. 3 illustrates an embodiment of an extensible media player. The media player application 300 may be instantiated in a client device, in, for instance, an Internet browser, or may function as a standalone media player application. The media player application 300 may be a Flash-based application. The media player application 300 may include a viewing screen 310 for displaying a selected media file. One or more modules associated with the selected media file may be downloaded and displayed prior to, concurrently with, or subsequent to the playing of the media file. In this embodiment, a banner module 320 may obscure the top portion of the video screen 310. The banner module 320 may display a banner advertisement concurrent to the playing of the selected media file. The placement and shape of the banner module 320 are not fixed; the banner module 320 may be placed anywhere in the video screen 310. In this embodiment, a player controls module 330 may transparently overlay the video screen 310 at the bottom of the video screen 310. The player controls module 330 may permit a user to control the playing of the selected media file. In this embodiment, the player controls module 330 may include a play button, a stop button, a pause button, and a volume adjustment control, but the player controls module 330 need not be limited to these controls and may include additional user controls.

In the event one or more of the modules fail to download or load properly, the instantiated or executed media player application 300 may nevertheless continue to operate without the failed module(s). As the modules provide additional functionality or presentation to the media player application, at a basic minimum, the extensible media player 300 may play the selected media file absent any of the modules, should the modules fail to download or load properly.

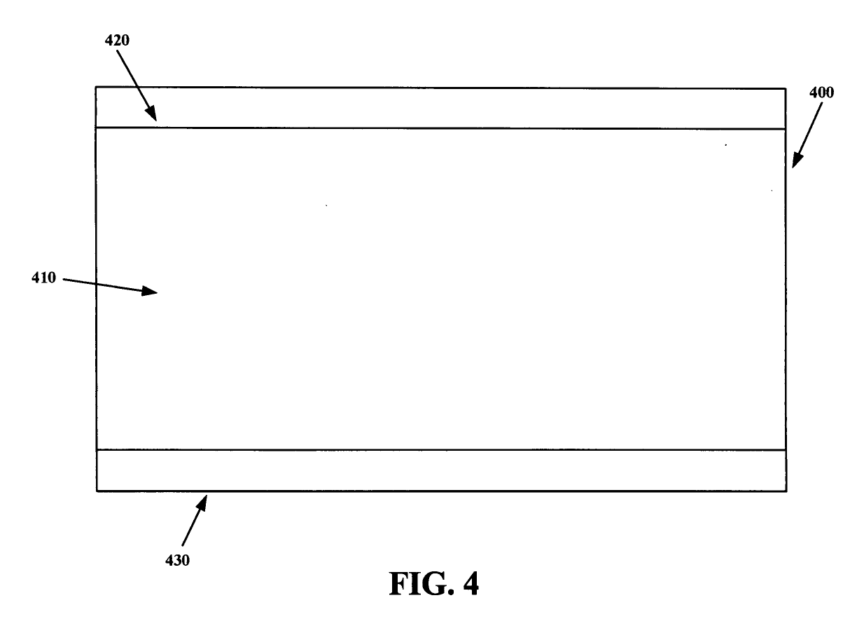

FIG. 4 illustrates an embodiment of an extensible media player. In this embodiment, a media player application 400, either instantiated or executed, may have loaded a selected media file and associated modules. One of the associated modules may be a pre-roll curtain module. The pre-roll curtain module may display an advertisement or other content prior to the playing of the selected media file. In this embodiment, an advertisement may be displayed in the video viewing screen 410. The pre-roll curtain module may include one or more banners 420, 430 which specify identifying information, such as the source of the advertisement displayed and the provider of the media file to be played. The duration of the pre-roll curtain module may be defined by the presentation data file. This duration is dynamic and may differ depending on, among other things, the media file presented or requirements specified by the advertiser. It is to be appreciated that all modules like the pre-roll module have the capability to retrieve their own configuration and policies outside of the presentation data file, like from a separate Ad systems network or multiple networks depending on the media file or advertising requirement.

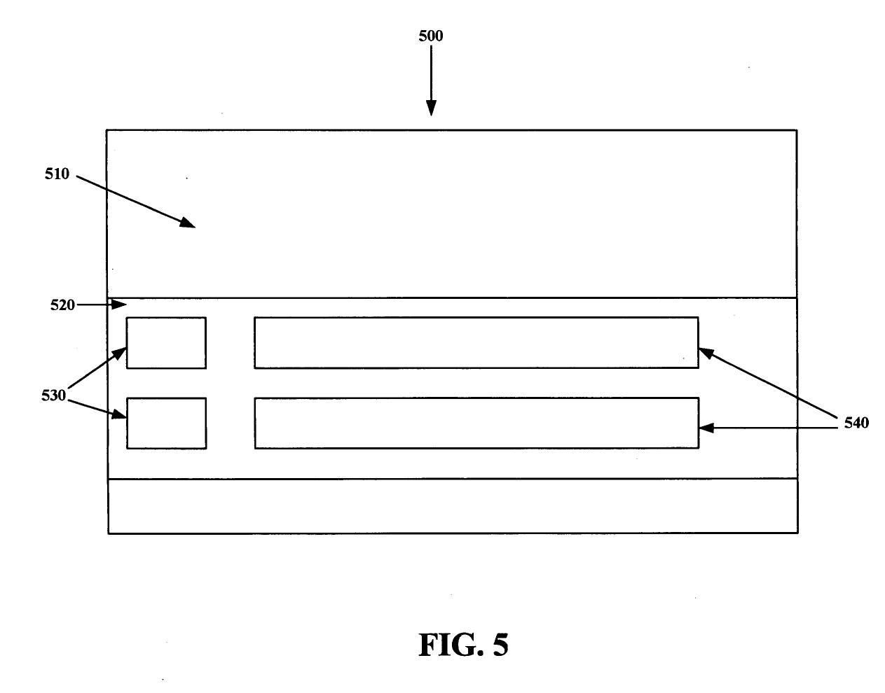

FIG. 5 illustrates an embodiment of an extensible media player. In this embodiment, a media player application 500, either instantiated or executed, and housed in a client device may load and play a selected media file in a video viewing screen 510. Accompanying the loading and playing of the selected media file may be selected modules, downloaded from a server and defined by a presentation data file transmitted from the server to the client device. One of the modules may be a clip list module 520 listing additional media files available for playback. The clip list module 520 may either transparently overlay or fully obscure part or all of the video viewing screen 510. The clip list module 520 may be interactive with the user, enabling the user to select a displayed clip for playback. In one embodiment, the clip list module may be displayed subsequent to the playing of a selected media file. Generally, the timing of execution of the clip list module 520 and other modules is defined in the presentation data file which is parsed and passed to the media player application 500. In another embodiment the lifetime of the clip list module may be defined by a Ad module or some other module not including the media clip metadata itself that defines restrictions for the module and content being displayed. The clip list module may include one or more thumbnail preview images 530 and accompanying captions 540 describing the subject matter of the media files.

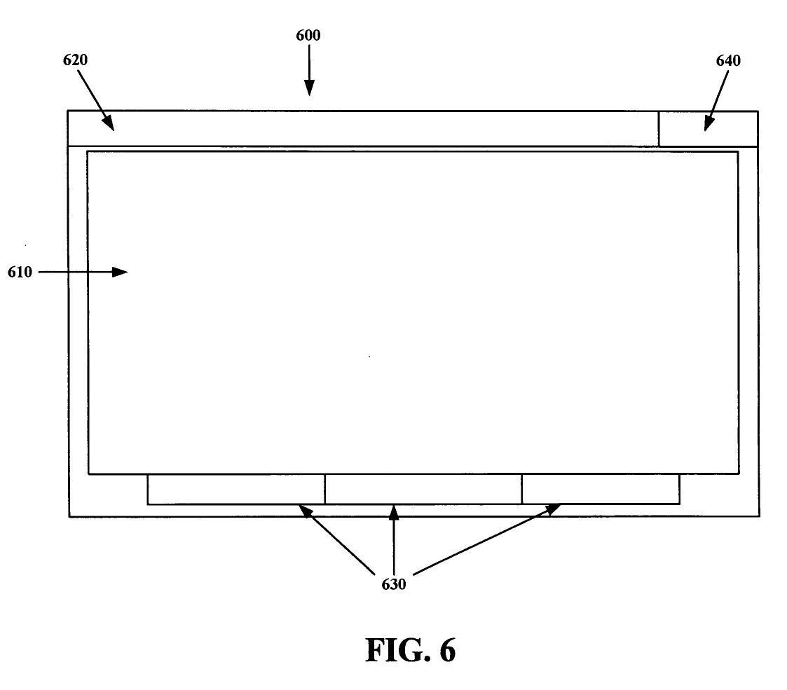

FIG. 6 illustrates an embodiment of an extensible media player. The extensible media player application may be configured to display rich media advertisements, which display an advertisement to a user and enable the user to interact with the advertisement. A rich media advertisement may be displayed any time prior to, concurrent with, or subsequent to the playing of a selected media file. The advertisement may be displayed when a video is paused or otherwise halted. The timing of the rich media advertisement may be defined by the presentation data file passed from the server to the client. In this embodiment, the rich media advertisement may include an advertisement displayed in a video viewing screen 610, accompanied by a banner 620 identifying the source of the advertisement, interactive banners 630 enabling a user to obtain additional information about the advertisement, and an exit button 640 enabling a user to close or exit from the advertisement. The duration and placement of these presentation aspects is not fixed and may be specified in the data presentation file. The interactive banners 630 may be configured to communicate with remote sources for retrieval of additional information related to the advertisement. In response to the selection of one of the interactive banners 630, the banners 630 may open additional browser windows and/or direct the user to a related content.

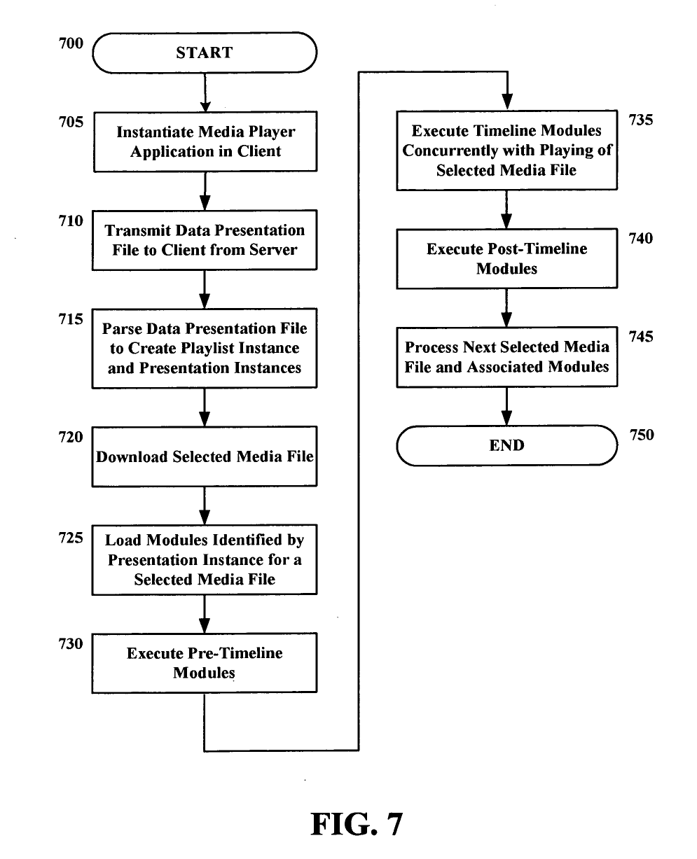

FIG. 7 is a flowchart illustrating one embodiment of a method for providing an extensible media player. In block 705, a media player application may be instantiated in a client device. In one embodiment, the media player application may be a Flash application embedded in a web page in an Internet browser. Alternatively, the media player application may be created as a Microsoft Silverlight™ application. In block 710, a presentation data file may be transmitted to the client device from the server. The presentation data file may be passed to the media player application from within a web page as a parameter or programmatically via JavaScript if the media player application is embedded in the web page. Alternatively, the media player application instantiated or residing in the client device may be given the source address of the presentation data file in order to fetch the presentation data file from a remote source in a network. The presentation data file may define a set of media files available for playback. Additionally, the presentation data file may specify one or more modules associated with each of the defined media files. These modules may affect an aspect of the presentation of a media file to a user or may extend the functionality of the media player application. The modules may control the presentation, playback, and other aspects of the media player through interaction with an API of the media player application. The presentation data file may specify presentation parameters for the modules affecting presentation aspects of the media file, such as, for example, the height, width, aspect ratio, transparency, and duration of the modules for a particular media file.

In block 715, the presentation data file may be parsed, and an instance of a playlist document may be passed to the media player application. The playlist instance may include a playlist items corresponding to media files available for playback. Each playlist item listed in the playlist may include an address or location from which a corresponding media file may be retrieved. A presentation instance may be created for playlist item listed in the playlist instance. The presentation instance may specify which modules and module-specific parameters are to be used by the media player application for a specific media file. In block 720, in response to a user selection of a playlist item, the media player application may request that a server transmit the requested media file corresponding to the playlist item to the client device. The server may transfer or stream the requested media file. In block 725, the media player application may load the downloaded or streamed media file and specified modules associated with the selected media file. The modules may be downloaded from URLs specified in the presentation data file. Version checking for each module may be performed using the module URL.

In block 730, pre-timeline modules, defined to be executed and/or displayed prior to the playing of the selected media file, may be executed. Examples of pre-timeline modules may include but are not limited to a pre-roll curtain displaying an advertisement, and a container module to house third party content which may conflict or be non-conforming with the media player application. In block 735, the media player application may load and play the selected media file. The media player application also may execute and/or display modules chosen to concurrently run with the playing of the media file. Such modules may include but are not limited to a banner module to display an advertisement during playing of the media file, a player controls module to display a set of user controls for controlling the playing of the media file, a closed captioning module to display closed captioning, and a clip list module to offer additional available media files for playback. In block 740, subsequent to the playing of the media file, the media player application may execute and/or display post-timeline modules. Post-timeline modules may include but are not limited to the clip list module and a post-roll curtain module to display an advertisement subsequent to the playing of the media file. In block 745, the media player application may process the next playlist item selected by a user. Processing may include downloading or streaming the media file, downloading associated modules, and loading the media file for the next playlist item and associated modules.

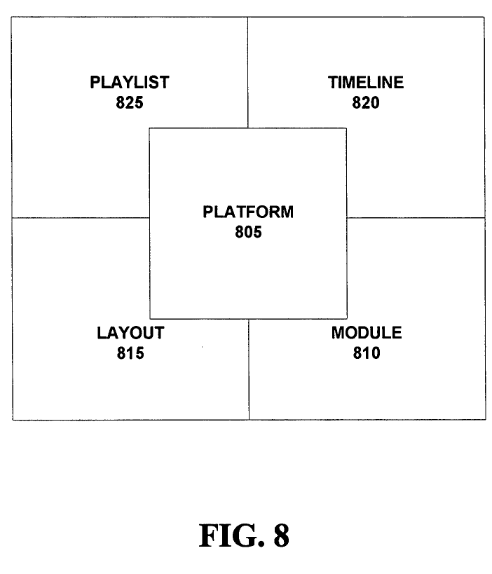

FIG. 8 illustrates an embodiment of a software platform supporting an extensible media player. While various applications and code supporting the software platform 805 may reside in and otherwise be supported by the system of FIG. 1, various system architectures and configurations may be employed. The platform 805 generally supports the embodiments disclosed herein. The platform 805 may support the use of various independent and decoupled modules 810 and layouts 815 to deliver an extensible media player. These modules 810 and layouts 815 may be programmatically delivered to the media player or via a data file. A sample high-level outline of a data file is shown below:

```
<?xml version=“1.0” encoding=“UTF-8”?>
<MTL xmlns=“http://video.yahoo.com/YEP/1.0/”>
  <Playlist>
    <Layouts/>
    <Modules/>
    <TimelineTemplates/>
    <Timelines/>
  </Playlist>
  <Data/>
</MTL>
```

The data file may describe and configure a media player application. The data file is structured in a hierarchical format, such that the data file may describe a playlist of timelines and associated media files or applications, and within the playlist, one or more layouts, modules, timelines, and timeline templates that are associated with one or more media files in the playlist. The modules 810, layouts 815, timelines 820, and playlists 825 may interface with the extensible media player platform via one or more APIs. In this respect, the platform offers to media player and module developers a standard base upon which to consistently process and interact with code or programs written for the extensible media player.

Each module 810 operates to extend a functionality or presentation aspect of the media player or to enhance the media player experience, such as through user interactivity. Each module may be decoupled from other modules such that each module operates independently of other modules. Because each module operates independently of other modules, a developer may create his or her own modules that may be injected or loaded into the platform to operate with the media player. However, even though modules are decoupled from each other, the modules may communicate and transfer data between and among themselves. A sample portion of a presentation data file with respect to modules is shown below:

```
<Modules>
<Module id=“jsapi” source=“http://yepstuff.com/JavascriptAPI.swf”
layoutTargetId=“_none”>
  <Parameters>
  <Parameter id=“event_function”>y_up_eventHandler</Parameter>
  </Parameters>
</Module>
<Module id=“video” source=“http://yepstuff.com/VideoPlayback.swf”
layoutTargetId=“video” isTimeSource=“true”/>
</Modules>
```

The modules associated with a particular media file also may be selected programmatically via the platform. Modules may run on an application level, a playlist level, or a timeline level. If a module is running on an application level, the module may always be active, and does not need to be defined for each timeline (corresponding to a media file or application) or playlist (corresponding to multiple media files or applications). If a module is running on a playlist level, the module will be active for each timeline located in the playlist. If a module is running on a timeline level, the module is running only when it is activated during the course of a specific timeline and associated media file or application.

A container-based layout approach may be used to organize the location of modules and media files within the media player application. Using this approach, one or more modules 810 may be placed within a layout container by the platform, with multiple containers capable of being used together to control the display of various modules when the media player is executed. Modules may be placed within a particular layout container by specifying a layout ID corresponding to the layout container in which the module is to be inserted. Use of containers to define the location of modules may eliminate the need to place modules directly on the display, and consequently logic or code previously used to define the size and placement of the modules on the display is unnecessary.

One supported module is a playback controls module that governs the execution or play back of media files in the player application. The playback controls module may include functionality for displaying the duration of a media file and controlling the playback of a media file, such as media player controls for playing, pausing, or stopping a media file, adjusting the volume of a media file and so forth. The playback controls module may provide additional functionality for interacting with a user if an application, such as a game, is presented to the user in place of a media file. For an application, the playback controls module may specify a duration in relation to some aspect of the application. For instance, if the application is a game, a game module may give a user 10 seconds to respond to a question. The playback controls module may display this 10 second duration to the user. A playlist 825 may store or maintaining a list of timelines to be played. As described in more detail below, each timeline may specify a set of modules and timing information, such as activation points (e.g., start and stop points), for each of the modules associated with the timeline. The modules associated with the timeline may playback one or more files of a media type (e.g., a multimedia file, an audio file) or may run one or more applications, such as a game. These media files and applications may be played back or executed at the same time if desired. The media file(s) or application(s) to be rendered may be determined by the modules associated with the timeline. The playlist 825 may maintain templates or common elements for one or more timelines. If a presentation data file is used to specify timelines to be loaded and modules and layouts to accompany the timeline to render media files or applications, the presentation data file may reference or call templates to be loaded for the timelines. The templates or common elements may define which modules 810 are to be used during the playback of the timeline and media files, with the advantage being that modules 810 commonly used by one or more timelines may be retrieved once and reused, thereby eliminating a need to call and retrieve the modules from the servers for each timeline. If templates are not used, the playlist 825 may store a list of timelines to be played, along with associated modules 810 and layouts 815 to be retrieved and used to render the presentation and playback of each media file.

In one embodiment, instead of using pre-roll, concurrent, and post-roll modules (relative to the playback of a media file) to control the timing of activation or execution of modules for a particular media file, a module 810 may serve as a timesource, or a timing reference to synchronize the activation or execution of other modules relative to the playback of the timeline and the media file. The timeline 820 may start playing and modules may activate and playback a media file or execute an application. As contemplated herein, a timeline may be a combination of modules, UI and data that is used to display one or more clips of media or one or more applications. The module(s) may execute or otherwise remain active for the duration of the timeline. Because the module 810 serves as a timing reference, other modules may be activated or called using the timing parameters maintained by the module 810. The timing references provided by the module 810 may be expressed in, for example, seconds elapsed or remaining, frames elapsed or remaining, percentage of media file played back or completed, percentage of the media file remaining, or any other way by which a media file or application may be measured. Sample code from a sample presentation data file with respect to the timeline is shown below:

```
<Timelines>
  <Timeline id=“timeline1” templateId=“defaultTimeline”/>
  <Timeline id=“timeline2” templateId=“defaultTimeline”>
    <!-- Layouts specific to timeline2 -->
    <!-- Metadata specific to/overridden by timeline2 -->
    <!-- Parameters specific to/overridden by timeline2 -->
    <!-- Modules specific to timeline2 -->
  </Timeline>
</Timelines>
```

Modules may include certain user interface elements that may be applied to the media player application. For instance, a module may include common graphical user interface elements, such as a button, a check box, a drop-down menu, or a text box. These examples are merely illustrative and are not intended to be limiting with respect to the types of graphical user interface (“UI”) elements capable of being supported by a module. Even if modules originate from different developers or sources, the modules should still offer a seamless look and feel to a user. For example, if first and second modules each have a button, the buttons from both modules should often have the same presentation to a user. The extensible media player may support the use of themes and stylesheets to provide a seamless look and feel for UI elements contained in the various supported modules. Themes may be sets of stylesheets. The themes and stylesheets may be stored at a server or central repository or may be passed to the platform programmatically. In one embodiment, the stylesheets may be similar to those of the Cascading Style Sheet (“CSS”) standard. The stylesheets may define or describe the presentation of various UI elements. In one embodiment, a stylesheet may describe the element to which the stylesheet applies and assign colors, states, margins and borders, text alignment, and fonts for the given element.

Unlike CSS, where a web browser or other application program applies a stylesheet to a document, web page, or set of graphical UI elements to control its presentation, the platform may not apply the theme or stylesheet to the modules. Since the platform primarily exists to provide a standard base from which various modules and components can interact with a media player, the platform may not know whether a module contains any UI elements. Instead, the modules may themselves retrieve or obtain themes and stylesheets to be applied to the UI elements contained within the modules. The modules may know that certain code and logic contained therein are directed to one or more UI elements. Because the module knows it has one or more UI elements, when instructed, the module may seek to retrieve or obtain the latest active theme to apply. The modules may be instructed to retrieve new themes or stylesheets to render their respective UI elements via the data file or programmatically. The modules may use a set of functions supported by the platform and the themes to, among other things, retrieve theme or stylesheet values for their respective UI elements. For instance, if a module has a button, the module may ask the platform to return values for the button. As part of the request for values, the module may specify its module ID if it has one, a type of element it wishes to obtain values for, an element ID for the element if one exists, or in the alternative, a class of stylesheet, a state to be assigned the UI element, and a fallback theme to be applied if no specific value for any element attribute is given. In order to maintain a uniform look and feel, a default theme may be applied to a UI element first, followed by the cascading of any specified or retrieved values for specific attributes. This way, the UI element will always have a default presentation. If the module fails to specify one or more attributes when requesting theme data values, default values may be returned to the module. Use of the default values may enable the UI element for a particular module to always have a uniform look and feel relative to the same or similar UI elements maintained by other modules.

In one embodiment, the cascading of themes and stylesheets may occur first at an application level using a default theme. As a playlist is loaded, a theme may be applied to the entire playlist or certain aspects of the playlist. The playlist theme may override the default application level theme for those attributes specified by the playlist theme. A specific timeline and its associated media file may have its own theme. Application of this timeline theme may override those attributes of UI elements for the particular timeline and associated media file, while UI elements associated with other timelines and media files, the playlist, and the media player application may remain unaffected. By cascading stylesheets and themes from an application level to a timeline level, various stylesheets and themes may be merged into one active stylesheet for the player.

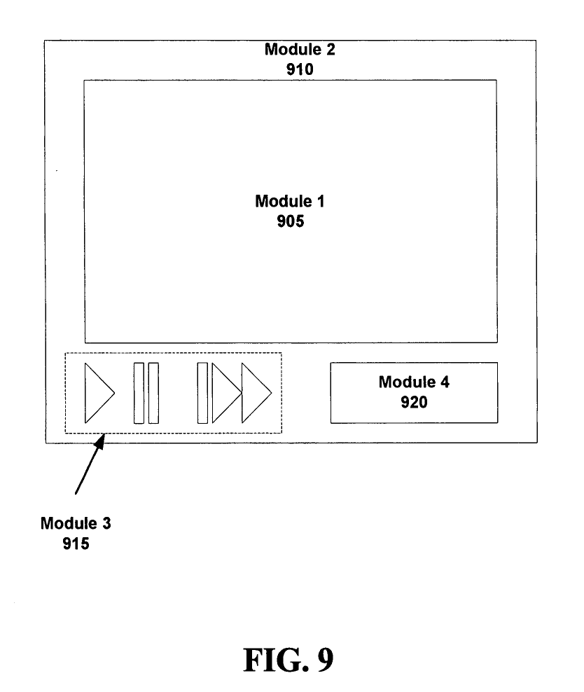

FIG. 9 illustrates an embodiment of an extensible media player. The player may include a first module, designated Module 1 905, which may be a module for the display screen of the media player application. A second module, designated Module 2 910, may be a module for a skin for the player application window. A third module, Module 3 915, may be a set of player controls for controlling the playback of a media file. A fourth module, Module 4 920, may be a button or other UI element capable of performing some function. Each module as shown in FIG. 9 may be the UI element of the module, with the code or logic of the module executing in the background or when the UI element of the module is selected. Each module may have an associated theme. For instance, a first theme, Theme 1, may specify that the playback controls of Module 3 should be black, any text should be blue, and any background should be green. A second, Theme 2, may specify that the UI element of Module 4 should be blue, the text should be green, and the background color should be red. In certain embodiments, if a player is sponsored by an advertiser, the skin of Module 2 910 may reflect a theme containing the advertiser's logo. In each case, the theme applied to the UI elements of the modules is requested and retrieved by the modules from the platform. The request or retrieval of the theme may be prompted by a programmatic command to change themes or by the data file that configures the player. Thus, for example, if one media file ends and a new media file is loaded, the data file may instruct the platform that a themeing change is needed. The theme change may be effected by replacing or adding the theme ID of the new theme to be rendered. The theme ID may be inserted in the data file, or may be passed to the platform programmatically. The platform may instruct the modules that a theme change is needed. In response, the modules may retrieve a new theme to accompany the new media file. The new themes may be rendered to give the player a new presentation for the new media file. In this respect, through the programmatic instructions or the data file, theme or stylesheet changes may be propagated to one or more decoupled modules running in their own independent environments. In contrast to conventional CSS, the platform may not contain a Document Object Model (DOM) that describes all of the elements needed to render a style or theme.

The data file used to propagate theme and style changes to the platform and the modules may be dynamic as well. During the lifetime of the player, the player can render or be given new themes and styles without having to refresh or reload the player or download a new player. Moreover, dynamic themeing and styling of a player may enable a player to adopt an advertisement theme during the playing of an advertisement. UI elements may be instructed during advertisements to disappear or become hidden.

The themeing and styling capabilities of the platform may further include the capability of the platform to automatically download assets or files, such as image assets or animation assets, used in various themes or styles. This automatic download capability may include the ability for the platform to retrieve these assets from a URL specified as the background. If a module loads and requests a large asset or file that has not been retrieved or is currently being retrieved by the platform, the platform may generate an event notification to the module when the asset has finished downloading.

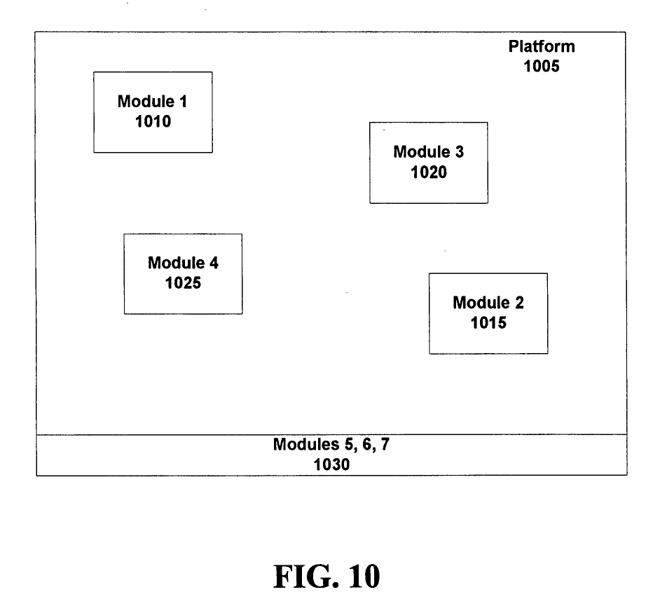

FIG. 10 illustrates an embodiment of an extensible media player platform. Multiple modules may be supported and executed by the platform 1005. As previously stated, a module may be application code and logic that extends the functionality of the media player application. While sources internal to the extensible media player development may supply the modules, third party developers likewise may design and provide their own modules for use with the media player. A data file may use these modules to describe and configure the player. For instance, the data file may indicate that Module 1 1010, Module 2 1015, and Module 3 1020 are to be used in conjunction with the media player, with a playlist of timelines that may each play a media file or run an application, or with a single timeline and associated media file or application. Alternatively, a third party developer could write a module that removes Modules 1 through 4 from the platform and replaces them with the developer's own set of modules.

An embodiment may exist in which a media player supplier may not want certain modules 1030 to be removed from the platform. In this case, these modules 1030 may be designated as secure or unloadable. An example of such a module may be a metrics module that reports and tracks advertisements, user interactions, and other metrics. By designating certain modules 1030 as unloadable or secure, these modules 1030 may not be removed during the lifetime of the player instantiation. Designation of such modules 1030 may occur via the data file. A sample of this data file is shown below:

```
<?xml version=“1.0” encoding=“UTF-8”?>
<MTL xmlns=“http://video.yahoo.com/YEP/1.0/”>
  <Modules>
  <Playlist>
    <Layouts/>
    <Modules/>
    <TimelineTemplates/>
    <Timelines/>
  </Playlist>
  <Data/>
</MTL>
```

As previously mentioned, the data file may hierarchically list a playlist, layouts, modules, and timelines that are associated with the player itself or certain media file(s). In one embodiment of the data file, modules may be specified on a playlist level such that the modules may apply to specified media files listed in the playlist. In this data file, a new hierarchy level may be added to accommodate designated secure or unloadable modules. This new hierarchy level may reside at a root, top, or application level. Modules designated on this module level may be unloadable or secure for the lifetime of the player.

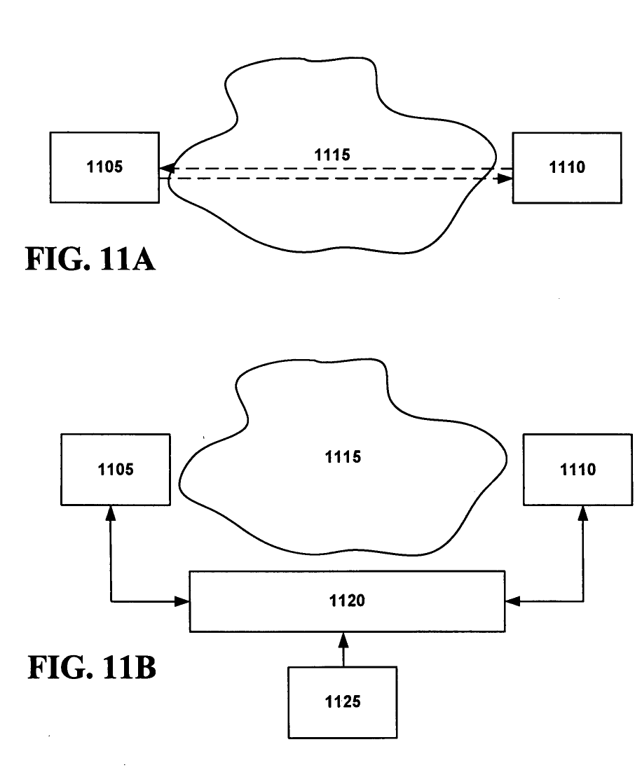

FIG. 11A illustrates an embodiment for module communication. Modules generally may operate independently such that no dependencies exist between the modules. This independency may enable modules developed by any developer to be supported by the extensible media player platform. However, in certain instances, modules may need to communicate and exchange data with each other. In one embodiment, the media player may be implemented using the Flash framework. However, the media player may be implemented using other known frameworks that support multimedia and rich Internet applications, such as Microsoft Silverlight. The framework by which the media player is implemented is not intended to be limiting. Modules operating in an exemplary Flash framework may use the Flash eventing mechanism to communicate via the standard Flash event dispatcher functions. When modules use the Flash event dispatcher however, developers of the modules and the player platform may not be able to track communications or events transpiring between the modules. Further, Flash communication events require the destination references for communications originating from a particular module. Given a platform objective of decoupled and independent modules, use of the Flash framework and a Flash event dispatcher may require a stronger coupling between modules than desired by the platform. Such communications or events are depicted in FIG. 11A. A first module 1105 may communicate with a second module 1110 through a Flash framework, depicted as element 1115.

FIG. 11B illustrates an embodiment for module communication. To track and log communication events between modules, an event manager 1120 may be employed. The event manager 1120 may be a layer within the platform that handles events raised by the various modules. For instance, when module 1105 wishes to communicate with or request an exchange of data with module 1110, module 1105 may raise an event. This event and data may be routed through and handled by the event manager 1120. In contrast to other conventional event managers, such as the Flash event dispatcher, the event manager 1120 may further track and log each raised event such that event manager 1120 will maintain, for example, a record that module 1105 raised event X at time Y. All events may thus be time-stamped and tracked through the event manager 1120. A metrics module or other module 1125 may access the event manager 1120 at any given time to retrieve tracked events and associated data exchanged between the various modules. Other modules may use this tracked event data for performance optimization and debug and error reporting purposes. The event manager 1120 enables the retrieval of all events transpiring between modules from a centralized source. This arrangement eliminates the need to interrogate each separate module to obtain event data.

An embodiment using the event manager may be described as follows. A playlist or carousel module 1110 may raise an event to retrieve information regarding a music video. The event manager 1120 may receive this event and pass it to a content management system module 1105 which is listening for this event. When the content management system module 1105 receives the request to retrieve information, the module 1105 finds the requested data from a web service with which it is communicating. When data retrieval from the web service is complete, the content management module 1105 may raise an event stating that the data request is complete. This event may be passed via the event manager 1120 to the carousel or playlist module 1110. When the module 1110 receives the event, it may begin receiving the data. The event manager 1120 may enable data associated with the event to be determined, such as when the request is made, when the request is satisfied, and how long the request took to complete. Further, because the modules are not coupled (through a Flash event dispatcher or other event handler), the content management system module 1105 may be replaced by a different module without affecting the carousel or playlist module 1110. It is conceivable that multiple modules may replace module 1105 or any module on one end of a communication. For instance, two content management system modules may replace the module 1105. One module may have access to a web service concerning the music video, while a second module may have access to a different web service concerning information about the music in the music video, such as album information, album art, album or song release date, etc.

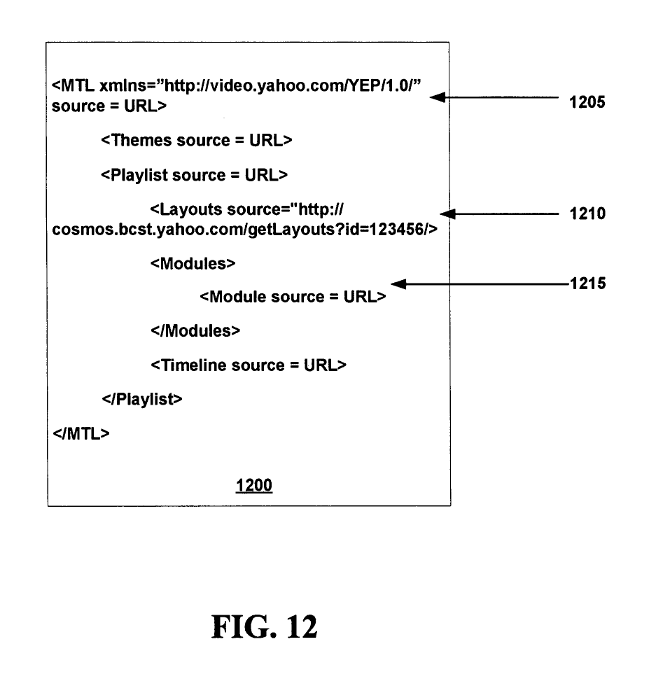

FIG. 12 illustrates a sample optimized data file for describing and configuring a media player application. The sample data file 1200 may be an XML file that describes and configures every aspect of a media player application, including themes, modules, playlists, layouts, timelines, timeline templates, metadata describing a media file, and data. In describing the aspects of the media player, the data file may become relatively large. Instead of storing a large static XML file in a server or dynamically generating the data file from a multitude of data, an optimized data file may be desired. The optimized data file may contain the minimum amount of data needed to configure a player application to operate.

The data file 1200 may be optimized by defining sources for high-level categories or items, such as themes, playlists, modules, etc. These sources may be identified by a URL, such that as the data file is parsed and compiled into the player, the content identified by the sources is retrieved. An exemplary source identifier is shown in FIG. 12 as element 1210. Source definitions need not be restricted to high-level categories. As shown in FIG. 12, a source definition 1215 may exist for a module defined at the playlist-level. A source 1205 may even be defined for the data file itself. This optimization enables the data file to be dynamic such that the resource pointed to by the source identifier may be switched as needed or desired. Further, by having the ability to change source identifiers, such as URLs, a player can be recreated dynamically after a change in a source identifier(s) so that a new player does not have to be delivered for each source change.

Optimization of a data file further may enable delivery of a new data file to a media player without reconstituting the player in a webpage. This delivery may solve the problem of how to configure or deliver new features to an already executing player without having to reinstantiate or refresh the player. One embodiment in which this capability may be advantageous is the delivery of a previously uncalled or unspecified module, such as metrics module, to an existing running player. If a metrics module is delivered to an existing running player, a developer may then have instrumentation to track the operation of the running player without having to refresh or reconstitute the player.

In another embodiment, the same player can be instantiated in a completely different form by qualifying the source URLs with a location identifier that defines a hosting page. This way the same player can be used to deliver, for example, news clips from a news source, such as Yahoo! News, and music clips from a music source, such as Yahoo! Music, with a completely different UI and functionality. Further it is to be appreciated, by using dynamically downloaded configuration, the initial player size and delivery can be drastically reduced, and modules may be loaded only on demand.

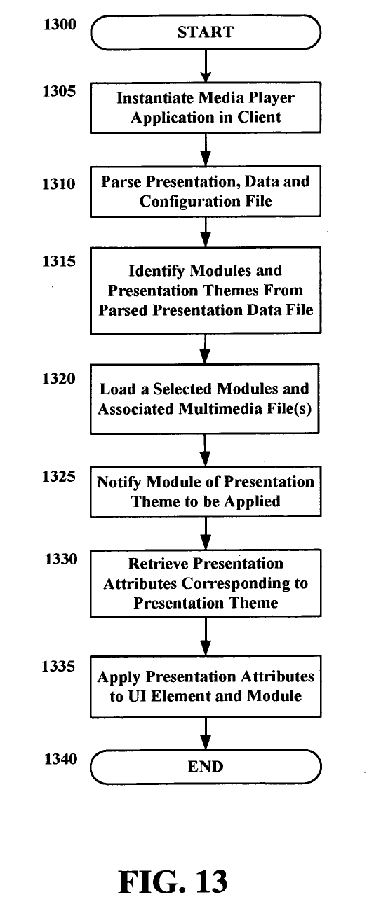

FIG. 13 is a flowchart illustrating one embodiment of a method for providing an extensible media player. In block 1305, a media player application may be instantiated in a client device or system. The media player application is capable of loading and playing one or more multimedia files simultaneously, such as video clips or audio files or executing one or more applications at the same time. In block 1310, a presentation, data, and configuration file transmitted to the client from a server may be parsed. The presentation data file may describe and configure the media player application. It is to be appreciated that the presentation data file could live anywhere, on the client itself, on the server or multiple servers and with parts of it dynamically generated based on requirements of the system. The presentation data file may specify a playlist of timelines to be loaded into the media player application, as well as modules associated with the media player application, the playlist, and individual timelines. Certain ones of these modules may specify a multimedia file or application, such as a game, to be played back by a timeline. Presentation themes may be specified in the presentation data file as well. Presentation themes may define presentation attributes for user interface (UI) elements that are located within the modules. These UI elements may include buttons, check boxes, as well as a media player display screen, playback controls, and other presentation aspects associated with the multimedia player. In block 1315, the parsed presentation data file may identify and create instances of the playlist and the playlist items corresponding to timelines. Modules and presentation themes associated with the playlist at a playlist level may be identified. Modules and presentation themes associated with specific timelines within the playlist also may be identified. In block 1320, a multimedia file identified by one of the modules associated with the playlist or the timelines in the playlist may be selected programmatically or through the presentation data file. Modules identified with the selected multimedia file may be loaded into the multimedia player application, thereby configuring the player to present the selected multimedia file. In block 1325, at the time of the modules are loaded and anytime thereafter, the media player application or the platform may notify the modules that a new or changed presentation theme or themes is to be applied to the user interface elements of the module.

In block 1330, the modules may retrieve presentation attributes from the platform using one or more functions. The module may submit a request to retrieve presentation attributes corresponding to the new presentation theme. The request may include the element type or element ID of the element to be rendered, as well as a state for the element. Presentation attributes may be returned in response to the module request. These presentation attributes may define the presentation aspects of the user interface elements, including color, background color, borders and margins, text alignment, etc. In block 1335, the modules may apply the returned and retrieved presentation attributes to their user interface elements, thereby rendering the user interface elements of the modules in a new and active theme. The process ends in block 1340.

Those of skill in the art will appreciate that an extensible media player may be enabled to facilitate the deployment of a multi-layered dynamic media player system. Such a system may be implemented and deployed without the delay of a traditional product cycle. The dynamic nature of the extensible media player allows for the media player application to be modified based on changing business needs and on a per view or per user basis. The present disclosure is not intended to be limited with respect to the type of device capable of implementing the extensible media player. Moreover, the present disclosure is not intended to be limited with respect to the modules and layouts disclosed herein. Additional modules and layouts may be employed to add functionality to the media player application or to control an aspect of the presentation of a media file played in the media player application.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. An extensible media player, comprising:
a media player application to load and play one or more multimedia files or load and execute one or more applications;
a plurality of modules, each module comprising application logic to extend functionality of said media player application and a user interface element having a reconfigurable presentation;
a plurality of presentation themes, each presentation theme defining presentation attributes of the user interface element for each of said plurality of modules; and
a presentation data file to identify a playlist of timelines, at least one module for each of the timelines, and a presentation theme to apply to each of the at least one module, wherein one of the at least one module identifies the one or more multimedia files to be played or the one or more applications to be run for the each of the timelines;
wherein said media player application parses said presentation data file, loads the at least one module associated with one of the timelines based on the parsing, and notifies each of the at least one module of its identified presentation theme, and
wherein the each of the at least one module retrieves the presentation attributes corresponding to the identified presentation theme and applies the presentation attributes to the user interface element.

2. The extensible media player of claim 1, wherein a module of the at least one loaded module is designated as unloadable from the media player application.

3. The extensible media player of claim 1, further comprising an event manager to maintain a log of events raised by the at least one module, the log of events comprising an event type, a time of occurrence of the raised event, a module raising the event, and any data transmitted during the event.

4. The extensible media player of claim 1, wherein the presentation data file stores source identifiers to the playlist, the at least one module for each of the timelines, and the presentation theme to apply to each of the at least one module instead of the playlist, the at least one module, and the presentation theme.

5. The extensible media player of claim 4, wherein the source identifiers are URLs.

6. The extensible media player of claim 1, wherein the presentation themes are Cascading Style Sheets.

7. The extensible media player of claim 1, wherein a default presentation theme is applied to the media player application, a first presentation theme is applied to the playlist of timelines, and a second presentation theme is applied to the at least one module for the selected timeline, wherein the presentation attributes of the first presentation theme override conflicting presentation attributes of the default presentation theme, and wherein the presentation attributes of the second presentation theme override conflicting presentation attributes of the default presentation theme and the first presentation theme.

8. The extensible media player of claim 1, wherein the presentation attributes include a user interface element type, a user interface element identifier, and an element state.

9. The extensible media player of claim 1, wherein the media player application further executes the at least one loaded module in an order and a location identified by said presentation data file.

10. The extensible media player of claim 1, wherein the media player application plays the one or more media files simultaneously or executes the one or more applications simultaneously.

11. A method, comprising:
instantiating a multimedia player application on a client system;
transmitting to the client system a presentation data file from a server, the presentation data file including a playlist of timelines, modules associated with each timeline of the playlist, and a first presentation theme for each of the modules, wherein one of the modules associated with each timeline identifies one or more multimedia files to be played or one or more applications to be executed, wherein each module extends functionality of the instantiated multimedia player application and includes a user interface element having a reconfigurable presentation, and wherein the first presentation theme defines presentation attributes of the user interface element for the each module;
parsing the presentation data file to identify the modules associated with each timeline on the playlist and the presentation theme associated with each module of the modules associated with the each timeline;
for a selected timeline from the playlist of timelines, loading the modules associated with the selected timeline;
notifying each module associated with the selected timeline of the presentation theme to be applied to the each module;
retrieving, by the each module associated with the selected timeline, the presentation attributes corresponding to the presentation theme to be applied to the each module; and
applying the presentation attributes to the user interface element of the each module.

12. The method of claim 11, further comprising designating a module of the loaded modules associated with the selected multimedia file as unloadable during a lifetime of the instantiated multimedia player.

13. The method of claim 11, further comprising when a module of the loaded modules associated with the selected multimedia file raises an event, logging the event in an event manager, said logging comprising recording an identifier of the module raising the event, an event type, a time of occurrence of the event, and any data transmitted during the event.

14. The method of claim 11, further comprising, replacing the playlist, the modules, and the presentation theme for the each of the modules with source identifiers to the playlist, the modules, and the presentation theme for the each of the modules.

15. The method of claim 11, wherein the source identifiers are URLs.

16. The method of claim 11, wherein the presentation theme is a Cascading Style Sheet.

17. The method of claim 11, further comprising:
applying a default presentation theme to the instantiated multimedia player application;
applying a second presentation theme to the playlist of timelines; and
applying the first presentation theme to the each module associated with selected timeline,
wherein the presentation attributes of the second presentation theme override conflicting presentation attributes of the default presentation theme, and
wherein the presentation attributes of the first presentation theme override conflicting presentation attributes of the default presentation theme and the second presentation theme.

18. The method of claim 11, wherein the presentation attributes include a user interface element type, a user interface element identifier, and an element state.

19. The method of claim 11, further comprising executing the at least one loaded module in an order and a location identified by said presentation data file.

20. The method of claim 11, wherein the one or more multimedia files are played simultaneously and the one or more applications are executed simultaneously.

21. A multimedia presentation system, comprising:
a server, storing a presentation data file, a plurality of multimedia files, a plurality of modules, and a plurality of presentation themes; and
a client, configured to communicate with said server, comprising a processing unit and a memory unit, said memory unit storing instructions adapted to be executed by the processing unit to:
instantiate a multimedia player application on a client system;
transmit to the client system the presentation data file from the server, the presentation data file including a playlist of timelines, modules associated with each timeline of the playlist, and a first presentation theme for each of the modules, wherein one of the modules identifies one or more multimedia files to be played or one or more applications to be executed for the each of the timelines, wherein each module extends functionality of the instantiated multimedia player application and includes a user interface element having a reconfigurable presentation, and wherein the first presentation theme defines presentation attributes of the user interface element for the each module;
parse the data presentation file to identify the modules associated with each timeline of the playlist and the presentation theme associated with each module of the modules associated with the each timeline;
for a selected timeline from the playlist of timelines, load the modules associated with the selected timeline;
notify each module associated with the selected timeline of the presentation theme to be applied to the each module;
retrieve, by the each module associated with the selected timeline, the presentation attributes corresponding to the first presentation theme to be applied to the each module; and
apply the presentation attributes to the user interface element of the each module.

22. The system of claim 21, wherein the processing unit further designates a module of the loaded modules associated with the selected multimedia file as unloadable during a lifetime of the instantiated multimedia player.

23. The system of claim 21, wherein the processing unit further logs an event in an event manager when a module of the loaded modules associated with the selected multimedia file raises the event, said logging comprising recording an identifier of the module raising the event, an event type, a time of occurrence of the event, and any data transmitted during the event.

24. The system of claim 21, wherein the processing unit further replaces the playlist, the modules, and the first presentation theme for the each of the modules with source identifiers to the playlist, the modules, and the presentation theme for the each of the modules.

25. The system of claim 21, wherein the source identifiers are URLs.

26. The system of claim 21, wherein the first presentation theme is a Cascading Style Sheet.

27. The system of claim 21, wherein the processing unit further:
applies a default presentation theme to the instantiated multimedia player application;
applies a second presentation theme to the playlist of timeliness and
applies the first presentation theme to the each module associated with selected timeline,
wherein the presentation attributes of the second presentation theme override conflicting presentation attributes of the default presentation theme, and
wherein the presentation attributes of the first presentation theme override conflicting presentation attributes of the default presentation theme and the second presentation theme.

28. The system of claim 21, wherein the presentation attributes include a user interface element type, a user interface element identifier, and an element state.

29. The system of claim 28, wherein the processing unit further executes the at least one loaded module in an order and a location identified by said presentation data file.

30. The system of claim 21, wherein the one or more multimedia files are played simultaneously and the one or more applications are executed simultaneously.
